(19) United States
(12) Patent Application Publication
(10) Pub. No.: US 2015/0103226 A1
(43) Pub. Date: Apr. 16, 2015

(54) OPTICAL LENS, LENS UNIT, IMAGING MODULE, AND ELECTRONIC APPARATUS

(71) Applicant: FUJIFILM Corporation, Tokyo (JP)

(72) Inventors: Hiroki TAKAHASHI, Saitama (JP); Gorou TAKADA, Saitama (JP); Tatsuya FUJINAMI, Saitama (JP); Yasunobu KISHINE, Saitama (JP)

(21) Appl. No.: 14/513,234

(22) Filed: Oct. 14, 2014

(30) Foreign Application Priority Data
Oct. 15, 2013 (JP) 2013-214730
Mar. 3, 2014 (JP) 2014-040560

(51) Int. Cl. G02B 1/11; G02B 5/20; G02B 13/00; G02B 27/00; G01J 1/04; G01J 1/42

(52) U.S. Cl. CPC G02B 1/11; G01J 1/0407; G01J 1/42; G02B 1/118; G02B 13/001; G02B 27/0018; G02B 5/208
USPC 348/335; 250/216; 359/601; 359/350

(57) ABSTRACT

An optical element includes an optical base material and a light blocking portion. The optical base material transmits light therethrough. The light blocking portion is formed on part of a surface of the optical base material. The light blocking portion includes a light blocking layer and an antireflection layer that is formed on a non-adhesion surface with the optical base material in the light blocking layer. A refractive index of the antireflection layer is lower than a refractive index of the light blocking layer.

### CROSS-REFERENCE TO RELATED APPLICATIONS

This application is based on and claims priority under 35 USC 119 from Japanese Patent Application No. 2013-214730 filed on Oct. 15, 2013, and Japanese Patent Application No. 2014-040560 filed on Mar. 3, 2014, the entire contents of which are incorporated herein by reference.

### BACKGROUND

1. Technical Field

The present invention relates to an electronic apparatus such as a digital camera Or a mobile phone, an imaging module which is incorporated and used in the electronic apparatus, and an optical lens and a lens unit mounted in the imaging module.

2. Related Art

In an imaging module which is incorporated and used in an electronic, apparatus such as a digital camera or a mobile phone, improvement has progressed in order to prevent the occurrence of flare or ghosting by removing torr incident light, thereby allowing the quality of a captured image to be improved. As an image quality countermeasure, for example, a configuration (refer to Patent Literature 1 (JP-A-2012-208390 and Patent Literature 2 (JP-A-2011-186437)) or the like has been proposed in which a light blocking layer is directly formed on a surface of a lens used in an imaging module.

In Patent Literature 1, a surface of the light blocking layer provided on the lens surface is made irregular, and thus incident light is prevented from being reflected at the surface of the light blocking layer.

Patent Literature 3 (JP-A-2010-243641), although not related to an imaging lens, discloses a technique in which a film having a refractive index distribution which decreases from one member side toward the other member side is provided between the two members, and thus is prevented from being reflected at interfaces of the two members.

### SUMMARY OF INVENTION

In recent imaging modules, a large diameter of a lens for increasing brightness and a reduced height for miniaturization have been required to be compatible, and this requirement is expected to become more strict in the future. For this reason, an incidence angle of light which is incident to a light blocking layer part of the lens mounted in the imaging module will further increase in the future, and thus there is a demand for a configuration in which reflection of light at a surface of the light blocking layer can be further minimized.

As an image quality improvement countermeasure, a light blocking layer having a diaphragm function is provided on a surface of an infrared cutoff filter on an optical lens side, and the infrared cutoff filter is provided between an imaging element and the optical lens. Also in this light blocking layer, an incidence angle of light further increases in the future in the same manner. In addition, the influence of reflection of light at a surface of the light blocking layer on captured image quality cannot be disregarded.

An illustrative aspect of the present invention is to provide an optical element which can prevent the occurrence of stray light by minimizing reflection of light at a surface of a light blocking layer, a lens unit using the optical element, an imaging module using the lens unit, and an electronic apparatus using the imaging module.

An aspect of the present invention provides an optical element including: an optical base material that transmits light therethrough; and a light blocking portion that is formed on part of a surface of the optical base material, in which the light blocking portion includes a light blocking layer; and an antireflection layer that is formed on a non-adhesion surface with the optical base material in the light blocking layer, and in which a refractive index of the antireflection layer is lower than a refractive index of the light blocking layer.

Another aspect of the present invention provides a lens unit including the optical element, in which the optical element is an optical lens, and the one or more optical lenses are arranged in an optical axis direction.

Another aspect of the present invention provides an imaging module including: the lens unit; and an imaging element that images a subject through the lens unit.

Another aspect of the present invention provides an electronic apparatus including the imaging module.

With any one of the aspects, it is possible to provide an optical element which can prevent the occurrence of stray light by minimizing reflection of light at a surface of a light blocking layer, a lens unit using the optical element, an imaging module using the lens unit, and an electronic apparatus using the imaging module.

### BRIEF DESCRIPTION OF DRAWINGS

FIG. 1 is a schematic cross-sectional view of an imaging module for explaining an embodiment of the present invention.

FIG. 2 is a partially enlarged cross-sectional view illustrating a cross-section including a lens optical axis Ax of an optical lens 15A.

FIG. 3 is a diagram illustrating a modification example of an enlarged part of a range B illustrated in FIG. 2.

FIG. 4 is a diagram illustrating a modification example of the enlarged part of the range B illustrated in FIG. 2.

FIGS. 5A to 5C are diagrams illustrating modification examples of a shape of a light blocking layer.

FIG. 6 is a schematic cross-sectional view illustrating a modification example of the imaging module.

FIG. 7 is a plan view of a light blocking portion 6.

FIG. 8 is a schematic cross-sectional view of the light blocking portion 6 of an infrared cutoff filter 7 illustrated in FIG. 6.

FIG. 9 is a schematic plan view illustrating a head of an ink jet printing apparatus used to manufacture the light blocking portion 6.

FIGS. 10A to 10C are diagrams illustrating a manufacturing method of the light blocking portion 6.

FIG. 11 is a diagram illustrating a manufacturing method of the light blocking portion 6.

FIG. 12 is a diagram illustrating a measurement system of Example.

FIG. 13 is a diagram illustrating a measurement system of Example.

FIG. 14 is a diagram illustrating a result of Examples.

### DESCRIPTION OF EMBODIMENTS

Hereinafter, an embodiment of the present invention will be described with reference to the drawings.

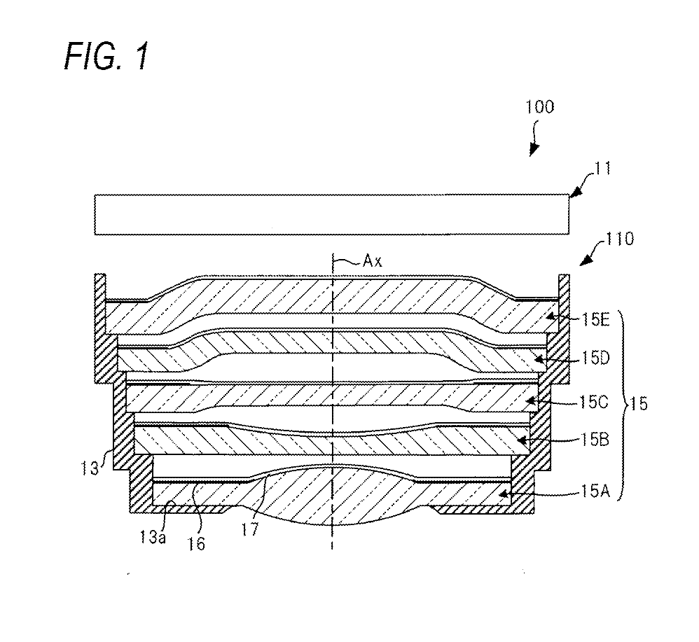

FIG. 1 is a schematic cross-sectional view of an imaging module for explaining an embodiment of the present invention.

An imaging module 100 is provided with a lens unit 110, and an imaging portion 11 including imaging elements, and is disposed inside a casing of an electronic apparatus such as a smart phone or a digital camera in a state of being supported by a support member such as a substrate (not illustrated).

The lens unit 110 includes one or more optical lenses 15 which are disposed so as to overlap each other in a lens optical axis Ax inside a lens holder 13. The plurality of optical lenses 15 fixed to the lens holder 13 collects light at the imaging portion 11 on the upper side of FIG. 1 from a subject side on the lower side of FIG. 1, and forms an optical image of the subject on a light receiving surface of the imaging element of the imaging portion 11.

FIG. 1 exemplarily illustrates five optical lenses 15A, 15B, 15C, 15D and 15E as the optical lenses 15, but the number of lenses is not limited thereto. The respective optical lenses 15A, 15B, 15C, 15D and 15E may be supported by a plurality of lens holders which are individually prepared, and a specific optical lens may be supported movably in an optical axis direction so as to configure a zoom lens mechanism, an automatic focusing mechanism, or a camera shaking prevention mechanism.

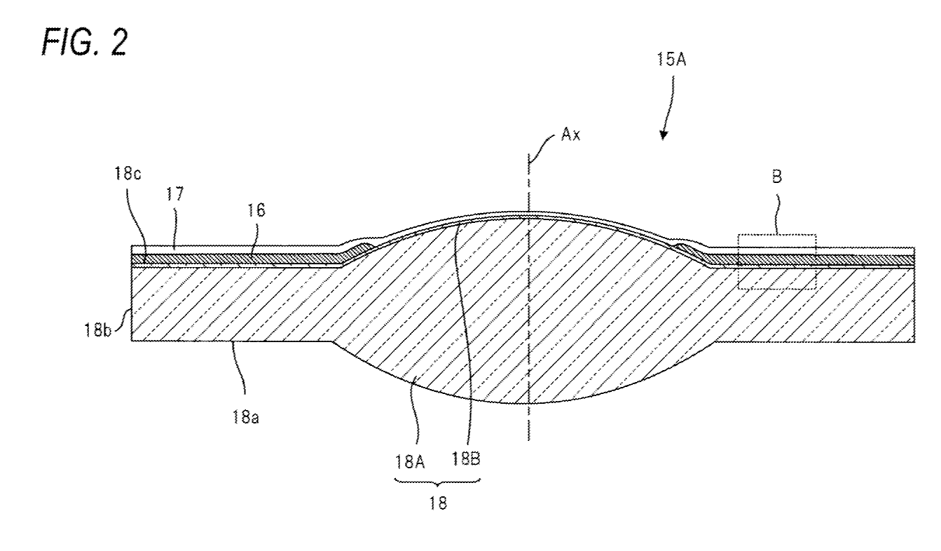

FIG. 2 is a partially enlarged cross-sectional view illustrating a cross-section including the lens optical axis Ax of the optical lens 15A. The optical lens 15A includes a lens base material 18 as an optical base material which transmits light beams therethrough, a light blocking layer 16 formed on part of a surface 18c of the lens base material 18, and an antireflection layer 17 formed on a non-adhesion surface with the lens base material 18 in the light blocking layer 16. A ng light blocking portion is constituted by the light blocking layer 16 and the antireflection layer 17.

The lens base material 18 is constituted by a lens base material body 18A and an antireflection coat (AR coat) 18B which is coated on a light emission surface side of the lens base material body 18A. The AR coat 18B may be omitted. In the following description, a refractive index of the lens base material 18 indicates a refractive index of the lens base material body 18A.

As a material of the lens base material body 18A, a transparent resin material having high light transmittance and shape stability, and good workability, such as cyclic olefin copolymer (COC), cycloolefin polymer (COP), or polycarbonate (PC), is preferably used.

The light blocking layer 16 is formed on the light emission side surface 18c in the surface of the lens base material 18, and prevents light which comes from an upper side of the light blocking layer 16 from being incident to the lens base material 18. The light blocking layer 16 may be formed on a surface 18b Which is supported by the lens holder 13 in the surface of the lens base material 18. The light blocking layer 16 may also be formed on part of a light incidence surface 18a in the surface of the lens base material 18. The light blocking layer 16 may be preferably formed on at least part of the surface 18c as illustrated in FIG. 2. The non-adhesion surface with the light blocking layer 16 in the surface of the lens base material 18 is also referred to as a lens portion.

The light blocking layer 16 may be formed by various methods such as printing, coating, and stamping of ink which contains light blocking substances such as black pigments or black dyes. Particularly, an ink jet method which allows high dimension accuracy to be obtained is preferably used.

As light blocking substances contained in the light blocking layer 16, various well-known black pigments or black dyes may be used. As a black coloring material, carbon black, titanium black, iron oxide, manganese oxide, or graphite which can realize a high optical density with a small amount thereof is preferably used. In addition, as a black coloring material, a mixture of a red coloring material, a green coloring material, and a blue coloring material may be used.

The antireflection layer 17 prevents reflection of light at the surface of the light blocking layer 16. The antireflection layer 17 may be formed on at least a non-adhesion surface with the lens base material 18 in the light blocking layer 16.

The optical lens 15A has a configuration in which a refractive index of the light blocking layer 16 is higher than a refractive index of the antireflection layer 17 in order to prevent reflection of light at the surface of the light blocking layer 16.

It is possible to prevent oblique light which is incident to the surface of the light blocking layer 16 from being reflected at the surface without using a light interference effect or the like by designing the refractive indexes of the light blocking portion provided between an Air layer and the lens base material 18 as mentioned above. The antireflection layer 17 is not particularly limited in materials used as long as the condition regarding refractive indexes is satisfied.

In recent imaging modules, a large diameter of a lens for increasing brightness and a reduced height for miniaturization have been required to be compatible, and this requirement is expected to become more strict in the future. If a focal length is shortened due to the reduced height, a viewing angle increases, and thus an incidence angle of light which is incident to an optical lens becomes widened. In addition, if a low F value which is a recent trend is employed, an aperture diaphragm diameter increases, and thus an incidence angle of light which is incident to an optical lens becomes widened. Here, the incidence angle is an angle formed between the optical axis of the optical lens and the light.

If an incidence angle of light becomes widened as mentioned above, ghosting increases. Although the light blocking layer 16 using black ink or the like is used to reduce ghosting if reflectance of the light blocking layer 16 is high, ghosting occurs due to reflection at the surface of the light blocking layer 16.

In addition, if a reduction in height progresses, a light path is required to be suddenly changed in each optical lens constituting a lens group, and thus there are increasing cases where light transmitted through the optical lens travels toward a sensor side with a great angle with respect to the optical axis. In the light blocking layer such as black ink, reflectance increases as an incidence angle of light increases, and thus ghosting with high intensity occurs due to the reduced height.

In consideration of these circumstances, the surface of the light blocking layer 16 is required to achieve an antireflection effect for light which is incident thereto at any angle. In a case where an antireflection layer having a multilayer structure using interference of light in the related art is used as the antireflection layer 17, the lens base material 18 is curved, and thus an appropriate antireflection effect cannot be achieved depending on positions of the layers. In contrast, according to the optical lens 15A of the present embodiment, reflection of light can be prevented at any position of the surface of the light blocking layer 16, and thus it is possible to minimize the occurrence of ghosting.

In FIG. 1, when a distance from the part which is closest to a subject in the optical lens 15A located on a subject side among the five optical lenses 15 to a light receiving surface of a solid-state imaging element included in the imaging portion 11 is set to TIT, and a composite focal length of the five optical lenses 15 is set to f, in the imaging module 100 in which a value obtained by dividing TTL by f is 1.3 or less, reflection of oblique light at the surface of the light blocking layer 16 due to the reduced height is considerable. For this reason, the configuration described in the optical lens 15A is notably effective to the imaging module 100 having a configuration satisfying this condition.

As mentioned above, although the light blocking portion of the optical lens 15A has been described, light blocking portions are also formed in all the optical lenses 15B, 15C, 15D and 15E of the lens unit 110 in the same manner. Consequently, it is possible to more reliably prevent the occurrence of flare or ghosting in the entire lens unit 110.

In the optical lens 15A illustrated in FIG. 1, if a configuration is employed in which a refractive index of the light blocking portion gradually increases from the surface which is in contact with the air layer toward the adhesion surface with the lens base material 18, it is possible to further achieve an antireflection effect.

Methods in which a refractive index of the light blocking portion gradually increases from the air layer side toward the lens base material 18 side will be described below.

First Method

As the antireflection layer 17, a so-called moth-eye (eyes of a moth) structure is employed in which repetitive pitches and heights of fine irregularities are smaller than a wavelength of visible light. As an antireflection structure using the moth-eye structure, a structure disclosed in, for example, JP-A-2004-50792 may be employed. In an antireflection layer using the moth-eye structure, a refractive index is made to gradually increase from the air layer side toward the light blocking layer 16 side, and a refractive index of an end part on the light blocking, layer 16 side is made smaller than a refractive index of the light blocking layer 16.

A film Of the moth-eye structure may be formed for example, by coating and drying an aqueous solution containing zinc nitrate and ethylenediamine on a substrate With a sodium hydroxide aqueous solution as a solvent so that zinc oxide (ZnO) is deposited. Zinc oxide has a network porous structure, and thus has a substantially moth-eye structure.

Alternatively, a film may be formed by using Alumina (Al₂O₃) or an aluminum nitride (AlN) oxide (refer to JP-A-2007-156017 and WO2011/111669).

In a case where the antireflection layer 17 having the moth-eye structure is formed by using ZnO, a refractive index of the antireflection layer 17 on the light blocking layer 16 side is about 1.65. For this reason, a refractive index of the light blocking layer 16 is required to be higher than 1.65. The smaller (preferably, 0.16 or less) a refractive index difference between the lens base material 18 and the light blocking layer 16 is, the further prevented the reflection of light at an interface therebetween is.

As the lens base material 18, there is a material having a refractive index of about 1.4 to 1.8 at a wavelength of 550 DM. For this reason, in a case where the antireflection layer 17 having the moth-eye structure is formed by using ZnO, it is preferable that a refractive index of the light blocking layer 16 at the wavelength 550 nm be higher than 1.65 and equal to or lower than 1.8, and a refractive index of the lens base material 18 at the wavelength 550 nm be 1.7 to 1.8, in order to effectively minimize ghosting.

In a case where the antireflection layer 17 having the moth-eye structure is formed by using Al₂O₃, a refractive index of the antireflection layer 17 on the light blocking layer 16 side is about 1.4. For this reason, when the antireflection layer 17 having the moth-eye structure is formed by using Al₂O₃, it is preferable that a refractive index of the light blocking layer 16 be higher than 1.4 and equal to or lower than 1.6, and a refractive index of the lens base material 18 be 1.5 to 1.6, in order to effectively minimize ghosting.

Second Method

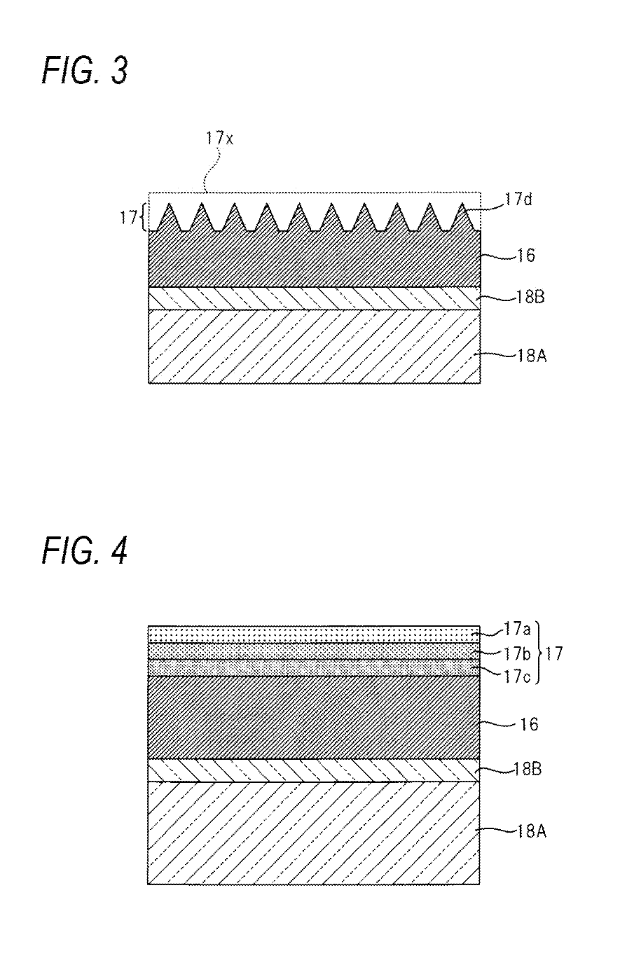

As illustrated in FIG. 3, convex parts 17d forming a moth-eye structure are provided on the surface of the light blocking layer 16. In this method, an aggregate of the convex parts 17d functions as the antireflection layer 17, and a part located under the convex parts 17d functions as the light blocking layer 16.

The structure illustrated in FIG. 3 is formed by coating a material of the light blocking layer 16 on the lens base material 18 through ink jetting or the like, then bringing a quartz mold 17x in which an irregular pattern of the moth-eye structure is farmed into pressing contact with the coated film before curing the coated film, and curing the coated film in this state. Then mold 17x is peeled off, and thus the convex parts 17d are formed.

Third Method

As illustrated in FIG. 4, the antireflection layer 17 is formed by using a laminate structure of a plurality of (in the example of FIG. 4, three) films 17a, 17b and 17c. In the antireflection layer 17 illustrated in FIG. 4, refractive indexes increase in an order of the film 17a, the film 17b, and the film 17c, and a refractive index of the film 17c is preferably lower than a refractive index of the light blocking layer 16.

In the optical lens 15A illustrated in FIG. 1, the antireflection layer 17 is formed on the surface of the lens base material 18 on which the light blocking layer 16 is not formed. In this configuration, in order to minimize ghosting, a difference between a refractive index of the antireflection layer 17 on the lens base material 18 side and a refractive index of the lens base material 18 is preferably small. If this difference is 0.11 or less, it is possible to effectively minimize ghosting.

If the difference between a refractive index of the antireflection layer 17 on the lens base material 18 side and a refractive index of the lens base material 18 is larger than 0.11, an antireflection layer of a material which causes a refractive index difference from the lens base material 18 to be equal to or smaller than 0.11 is required to be provided on the surface of the lens base material 18 on which the light blocking layer 16 is not provided, separately from the upper part of the light blocking layer 16. As in the present embodiment, when the difference between a refractive index of the antireflection layer 17 on the lens base material 18 side and a refractive index Of the lens base material 18 is equal to or smaller than 0.11, an antireflection layer on the light blocking layer 16 and an antireflection layer on the lens base material 18 are not required to be formed separately. For this reason, manufacturing steps of the optical lenses can be simplified, and thus manufacturing costs can be reduced.

The kind of lens to which the present invention is applicable is not limited to the above-described disc-shaped convex lens or concave lens. A meniscus lens, a cylindrical lens having a cylindrical lens surface, a ball lens, a rod lens, and the like may be used. The above-described same light blocking portion is provided in these various lenses, and thus it is possible to prevent the occurrence of flare or ghosting.

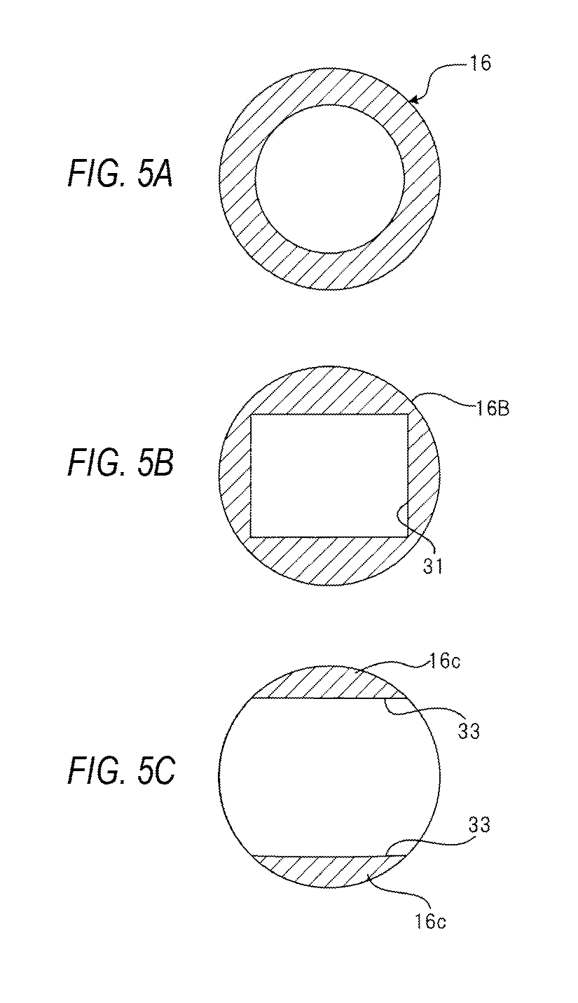

A planar shape of the light blocking layer 16 may be annular as illustrated in FIG. 5A, and a light blocking layer 16B having a rectangular opening 31 whose inner circumference is formed in a rectangular shape may be used as illustrated in FIG. 5B. As illustrated in FIG. 5C, a pair of “D”-shaped light blocking layers 16c which restricts only angles of view of upper and lower ends may be disposed on an optical lens with straight line parts 33 facing each other.

Although an optical lens has been described hitherto as an example of an optical element in which the light blocking layer is provided, the present invention is applied to a configuration in which an infrared cutoff filter provided between an imaging lens and an optical lens is provided with as light blocking portion, and thus ghosting or flare can be minimized. In this case, the infrared cutoff filter is an optical base material which transmits light beams (light excluding infrared rays) therethrough.

In the imaging module, light incident to a light blocking portion on an infrared cutoff filter surface includes a lot of oblique light. If the oblique light is into the light blocking portion on the infrared cutoff filter surface, there is the occurrence of light (referred to as regularly reflected light) which is regularly reflected at the light blocking portion and light (referred to as backward reflected light or backward scattered light) which is scattered at the light blocking portion surface and returns in a direction of the incident light. There is a high probability that these two light beams may be reflected at the optical lens surface and return to the imaging lens, and this causes the occurrence of ghosting.

In order to minimize ghosting, in a configuration in which the infrared cutoff filter is provided with the light blocking portion, as exemplified in FIG. 3, a surface shape of the light blocking portion is an irregular shape described later. In this case, the present inventor has found that ghosting can be minimized by reducing regularly reflected light at the light blocking portion surface and by causing light which returns in a direction of incident light to have high directivity (by reducing scattering). Hereinafter, a preferred embodiment of an imaging module equipped with an infrared cutoff filter having a light blocking portion will be described.

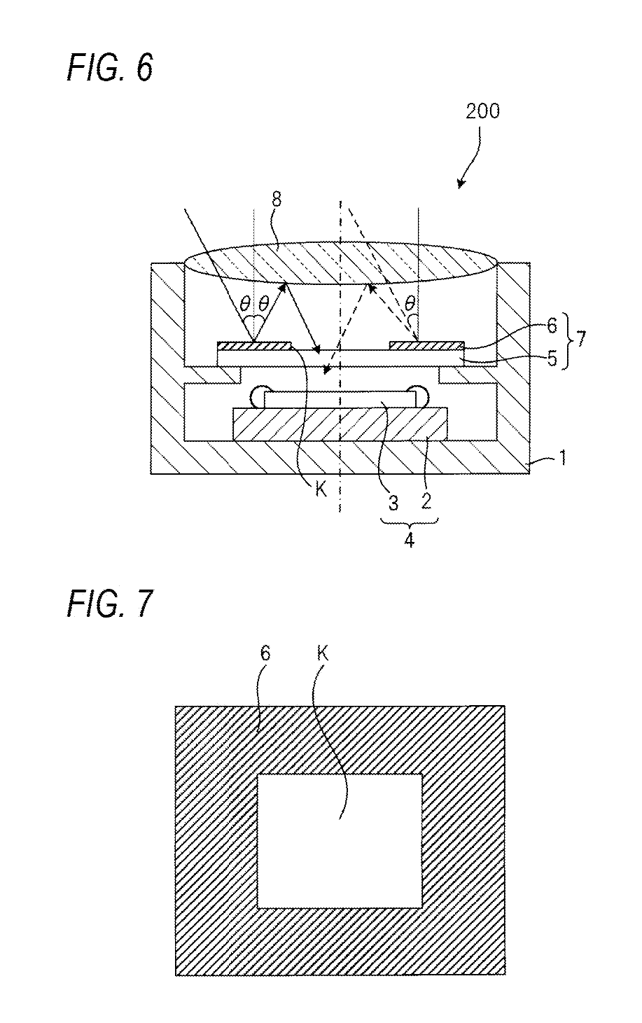

FIG. 6 is a schematic cross-sectional view illustrating a modification example of an imaging module.

An imaging module 200 illustrated in FIG. 6 includes a casing 1, an imaging portion 4 including a substrate 2 disposed on a bottom of the casing 1 and an imaging element 3 formed on the substrate 2, an infrared cutoff filter 7 formed over the imaging element 3, and an optical lens 8 formed over the infrared cutoff filter 7. The optical lens 8 is constituted by at least one optical lens in the same manner as the optical lenses 15 of FIG. 1.

The infrared cutoff filter 7 includes a filter body 5 as an optical base material which transmits light therethrough and a light blocking portion 6 formed on the filter body 5. The filter body 5 is a main body part which attenuates infrared rays (generally, light with a wavelength of 700 nm or longer), and uses a well-known blocking body. The light blocking portion 6 may be formed by the same method (for example, the method illustrated in FIG. 3) by using the same material as that of the above-described light blocking layer 16.

FIG. 7 is a plan view of the light blocking portion 6. As illustrated in FIG. 7, in the tight blocking portion 6, an opening K is formed in a region including an optical axis of the Optical lens 8. The opening K can reduce oblique light which is incident to the imaging element 3.

Fin, 8 is a schematic cross-sectional view of the light blocking portion 6 of the infrared cutoff filter 7 illustrated in FIG. 6.

The light blocking portion 6 is constituted by a flat part 62 which is a part having a uniform thickness as a whole, and a plurality of quadrangular pyramid-shaped convex parts 61 which are arranged in a two-dimensional manner on the flat part 62. A surface of the light blocking portion 6 is formed in an irregular shape due to the plurality of convex parts 61. The convex parts 61 are not limited to the quadrangular pyramid shape, and may have any convex shape such as a conical shape, a trigonal pyramid shape, or a prism shape. The flat part 62 may have a thickness which allows light to be blocked. The flat part 62 of the light blocking portion 6 functions as a light blocking layer. An aggregate of the plurality of convex parts 61 functions as an antireflection layer which prevents reflection of light at the surface of the flat part 62. A refractive index of the antireflection layer constituted by the plurality of convex parts 61 is smaller than a refractive index of the flat part 62 due to the irregular shape thereof.

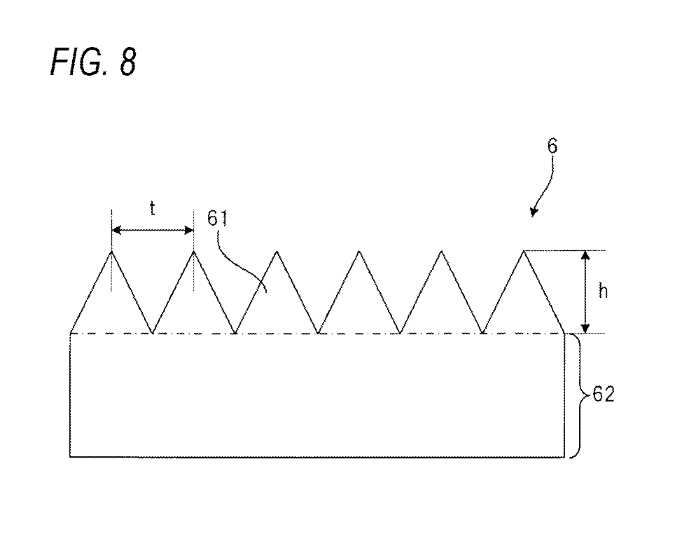

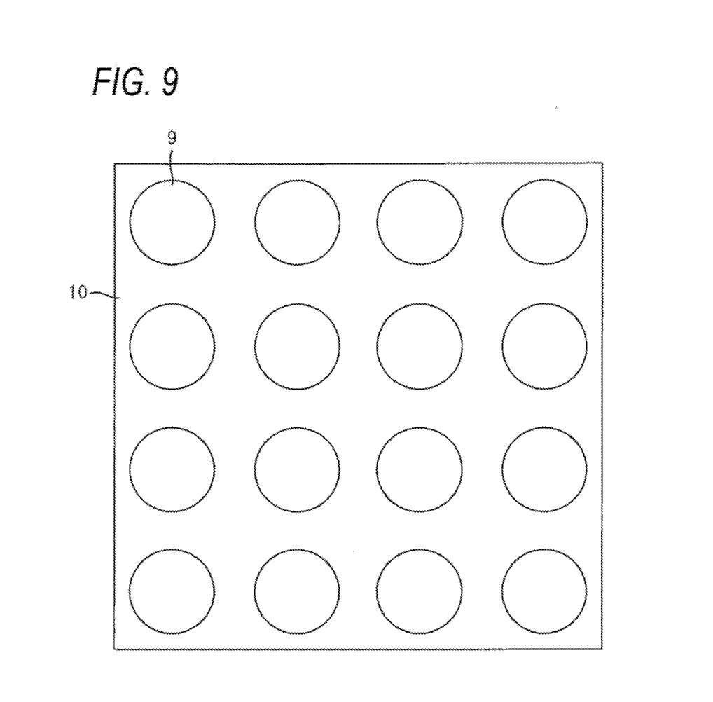

An average (indicated by an average height H) of heights Ii of all the convex parts 61 located on the surface of the light blocking portion 6 is 400 nm or more, and is preferably 500 nm or more and 1000 nm or less. In the example of FIG. 8, the heights of the convex parts 61 are uniform, and thus the heights h and the average height H are the same value.

An average arrangement pitch (indicated by T) of all the convex parts 61 located on the surface of the light blocking portion 6 is 150 nm or more and 700 nm or less, and is preferably 150 nm or more and 500 nm or less. In the example of FIG. 8, the convex parts 61 are arranged in a square lattice form with uniform arrangement pitches t, and thus the arrangement pitches t and the average arrangement pitch T are the same value.

Each arrangement pitch t Of the convex parts 61 indicates a maximum value of a width in a direction in which two convex parts 61 are arranged in a space (concave part) interposed between the two adjacent convex parts 61. The two adjacent convex parts 61 indicate that other convex parts 61 are not present between the two adjacent convex parts 61.

If the irregular shape of the surface of the light blocking portion 6 satisfies such a condition, it is possible to reduce regularly reflected light (the solid line arrow in FIG. 6) which is reflected with a reflection angle θ among light beams which are incident to the infrared cutoff filter 7 with an incidence angle θ. In addition, among the light beams which are incident to the infrared cutoff filter 7 with the incidence angle θ, a scattering angle of backward scattered light (the clashed line arrow in FIG. 6) which is scattered in an incidence direction can be reduced. As mentioned above, since regular reflection is reduced, and backward scattering is made to have directivity, ghosting can be minimized.

The light blocking portion 6 having the configuration illustrated in FIG. 8 is preferably manufactured as follows.

FIG. 9 is a schematic plan view illustrating a configuration of a head of an ink jet printing apparatus used to manufacture the light blocking portion 6.

In a head 10 illustrated in FIG. 9, a plurality of (in the example of FIG. 9, sixteen) nozzles 9 for ejecting an energy curable material are arranged in a two-dimensional form. The head 10 is scanned in a two-dimensional form so as to form the light blocking portion 6, but, in the following, a manufacturing method of the light blocking portion 6 will be described by using a single nozzle 9 included in the head 10.

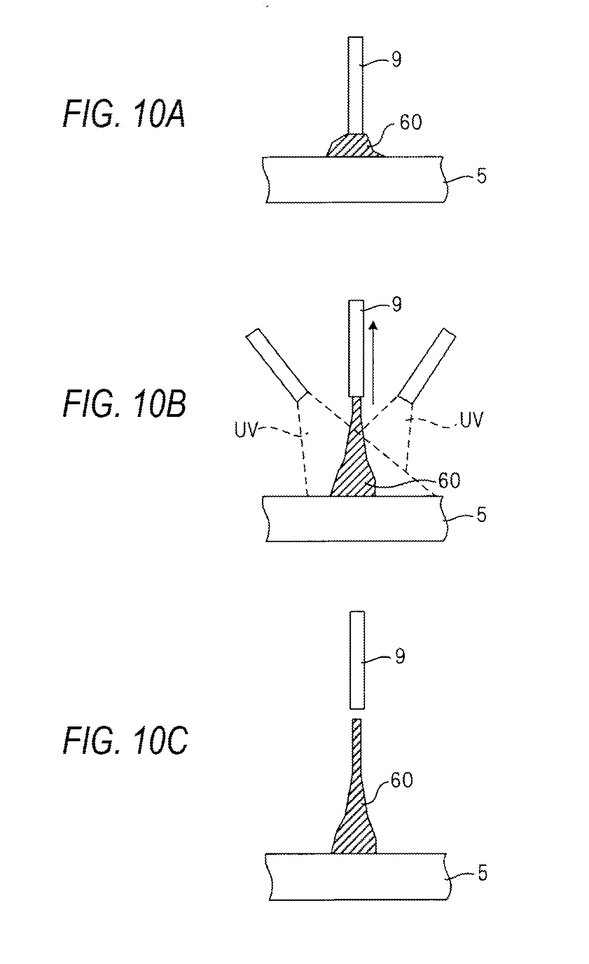

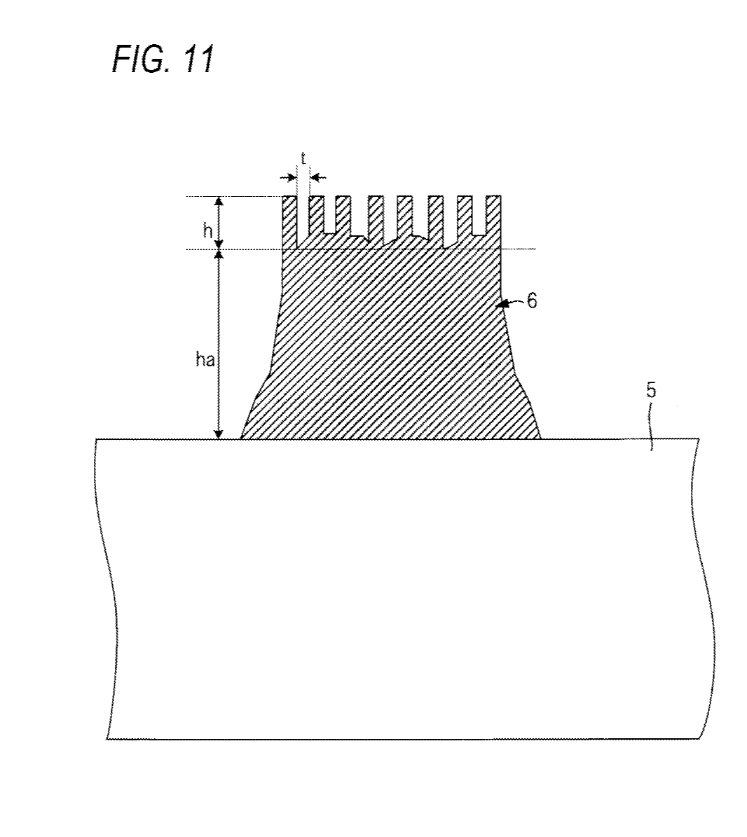

FIGS. 10A to 10C are diagrams illustrating a manufacturing method of the light blocking portion 6.

As illustrated in FIG. 10A, the nozzle 9 is made to come close to the filter body 5, and an energy curable material 60 is ejected from the nozzle 9 to the filter body 5. The energy curable material 60 may be any material as long as the material can be cured by energy such as heat or light. Herein, as the energy curable material 60, an ultraviolet-ray curable resin (surface tension: 30 N/m, and viscosity: 100 cps) containing carbon black (average particle diameter: 0.3 μm) is used.

Next, the nozzle 9 is moved in a direction of being separated from the surface of the filter body 5 in a state in which the ejected ultraviolet-ray curable material 60 is in contact with the nozzle 9. A height of the ultraviolet-ray curable material 60 at this time is 20 μm. Some energy which is required to cure the ejected ultraviolet-ray curable material 60 is supplied thereto, so that the ejected ultraviolet-ray curable material 60 is cured by half (FIG. 10B). Herein, the ultraviolet-ray curable material 60 is irradiated with ultraviolet rays under conditions of power of 2 W/cm², a wavelength of 385 nm, and an irradiation tune of 30 seconds, in an atmosphere of oxygen of 100 ppm or less.

After some of the energy is supplied thereto, the nozzle 9 is further moved in the direction of being separated from the surface of the filter body 5 so that the nozzle 9 is separated from the half-cured ultraviolet-ray curable material 60 (FIG. 10c). Herein, the nozzle 9 is moved by 1.5 μm at a movement speed of 1.5 μm/sec. Since the ultraviolet-ray curable material 60 is in a half-cured state, the ultraviolet-ray curable material 60 can be extended in tracking of the movement of the nozzle 9. As a result of detailed tests, in a case where a movement speed of the nozzle 9 is 1.5 μm/sec, it has been found that a relationship of 3f=h is established between a movement amount f of the nozzle 9 and a height h of the convex part.

Next, energy required for curing is supplied to the separated ultraviolet-ray curable material 60, so that the separated ultraviolet-ray curable material 60 is completely cured. Herein, the ultraviolet-ray curable material 60 is irradiated with Ultraviolet rays under conditions of power of 4 W/cm², a wavelength of 385 nm, and an irradiation time of 30 Seconds, in an atmosphere of oxygen of 100 ppm or less.

The above-described steps are simultaneously performed by using the all the nozzles 9 mounted on the head 10, and the same steps are repeatedly performed while a position of the head 10 is moved. Thus, as illustrated in FIG. 11, the light blocking portion 6 can be formed which includes a flat part having a thickness ha, and convex parts having heights h, arranged with arrangement pitches t on the flat part.

Herein, although an example in which the plurality of nozzles 9 are mounted on the head 10 has been described, a single nozzle 9 may be mounted on the head 10, and the head 10 may be scanned so that the light blocking portion 6 is formed.

According to the above-described manufacturing method, expensive apparatuses are not necessary, and a large amount of initial investment such as a lithography method is not required. Thus, it is possible to reduce manufacturing costs. A simple process is performed in which an energy curable material is coated and is then cured, and thus it is possible to realize high productivity.

A digital camera has been described as an example of an incorporation target of the above-described imaging module 100, but an incorporation target is not limited thereto. Other incorporation targets of the imagining module 100 may include, for example, a PC camera which is built into a personal computer (PC) or is externally attached thereto, an interphone with a camera, an in-vehicle camera, or an electronic apparatus having a photographing function, such as a portable terminal apparatus or an electronic endoscope. The portable terminal apparatus may include, for example, a mobile phone, a smart phone, a personal digital assistant (PDA), or a portable gaming machine.

As mentioned above, the present invention is not limited to the above-described embodiment, and combinations of the respective configurations of the embodiment, and modifications and applications by a person skilled in the art based on the disclosure of the specification and well-known techniques are intended to be covered by the present invention and are thus included in the scope of the protection sought.

Hereinafter, Examples of the present invention will be described.

A result of examination of the optical lens 15A illustrated in FIG. 2 will be described.

In Comparative Example 1 and Examples 1 to 9 described below, either A or B shown in the following Table 1 was used in the light blocking layer 16. In addition, either a or b shown in the following Table 2 was used in the lens base material body 18A. Refractive indexes were measured by using Ellipsomneter VASE manufactured by J. A. Woollam Japan Co, Inc.

TABLE 1

| Material | Product Name | Refractive Index at 546 nm |
|---|---|---|
| A | Black Ink LL004 by | 1.58 |
| | FujiFilm Corporation | |
| B | GT20 by Canon Inc. | Arbitrarily Adjustable |

TABLE 2

| Material | Product Name | Refractive Index at 546 nm |
|---|---|---|
| a | ZEONEX (Registered | 1.54 |
| | Trademark) F52R by Zeon | |
| | Corporation | |
| b | MR-174 by Mitsui | 1.74 |
| | Chemicals, Inc. | |

### Comparative Example 1

An AR coat was applied on a lens base material body made of the material a so that a lens base material was formed, and then the material A was coated on part of a surface of the lens base material by an ink jetting method and was then dried and cured so that a light blocking layer was formed.

### Example 1

An AR coat was applied on a lens base material body made of the material a so that a lens base material was formed, and then the material A was coated on part of a surface of the lens base material by an ink jetting method. Then, a mold having a moth-eye irregular structure was brought into pressing contact with the coated film of the material A, and the coated film was cured in this state so that an antireflection layer and a light blocking layer were formed. A part where irregularities were formed in the cured coated film is divided into ten parts in a direction perpendicular to the surface of the lens base material, and a refractive index of each divided layer was measured and results are shown in Table 3. In Table 3, a smaller layer number indicates that a corresponding layer is closer to an air layer.

TABLE 3

| Layer | Spatial Occupation Ratio [%] | Effective Refractive Index |
|---|---|---|
| 1 | 0.826 | 1.004 |
| 2 | 3.306 | 1.015 |
| 3 | 7.438 | 1.033 |
| 4 | 13.223 | 1.059 |
| 5 | 20.661 | 1.093 |
| 6 | 29.757 | 1.135 |
| 7 | 40.496 | 1.186 |
| 8 | 52.893 | 1.246 |
| 9 | 66.942 | 1.317 |
| 10 | 82.645 | 1.401 |

### Example 2

An AR coat was applied on a lens base material body made of the material b so that a lens base material was formed, and then the material B was coated on part of a surface of the lens base material by an ink jetting method and was then dried and cured so that a light blocking layer was formed. Then, an aqueous solution containing zinc nitrate and ethylenediamine was coated and dried on the light blocking layer with a sodium hydroxide aqueous solution as a solvent so that zinc oxide was deposited, thereby allowing an antireflection layer with a moth-eye structure to be formed. The antireflection layer has a refractive index which is slightly higher than 1 on the air layer and a refractive index of 1.65 on the light blocking layer side.

### Example 3

Au antireflection layer with a moth-eye structure, made of Al₂O₃ was formed on the light blocking layer of the optical lens which was manufactured in Comparative Example 1. The antireflection layer has a refractive index which is slightly higher than 1 on the an layer side and a refractive index of 1.4 on the light blocking layer side.

### Example 4

An optical lens was manufactured by the same method as in Example 3 except that a light blocking layer material is changed to B.

### Example 5

A film of the material B was formed on the light blocking layer through deposition so that an index matching (IM) layer was formed in the manufacturing process of the optical lens of Example 4. Then, an antireflection layer made of Al₂O₃ was formed on the IM layer.

### Example 6

The surface of the optical lens manufactured in Comparative Example 1 was roughened through laser blasting, and then a film of MgF₂ was formed on the light blocking layer by an EB deposition method so that an IM layer was formed. Since MgF₂ buries shavings of the light blocking layer generated during the laser blasting, a refractive index of the IM layer is a value between refractive indexes of the material A of the light blocking layer and MgF₂. The refractive index of the IM layer was 1.5 at a wavelength of 546 nm. Next, a film of MgF₂ was formed on the IM layer by an EB deposition method so that an antireflection layer was formed. A refractive index of the antireflection layer was 1.4 at a wavelength of 546 nm.

### Example 7

The material B was coated on part of a surface of a lens base material body made of the material a by an ink jetting Method and was then dried and cured so that a light blocking layer was formed. Then, an antireflection layer with a moth-eye structure, made of ZnO, was formed on the light blocking layer and the surface of the lens base material body by the same method as in Example 2.

### Example 8

The material B was coated on part of a surface of a lens base material body made of the material b by an ink jetting method and was then dried and cured so that a light blocking layer was formed. Then, an antireflection layer with a moth-eye structure, made of Al₂O₃, was formed on the light blocking layer and the surface of the lens base material body.

### Example 9

The material B was coated on part of a surface of a lens base material body made of the material b by an ink jetting method and was then dried and cured so that a light blocking layer was formed. Then, an antireflection layer with a moth-eye structure, made of ZnO, was formed on the light blocking layer and the surface of the lens base material body by the same method as in Example 2.

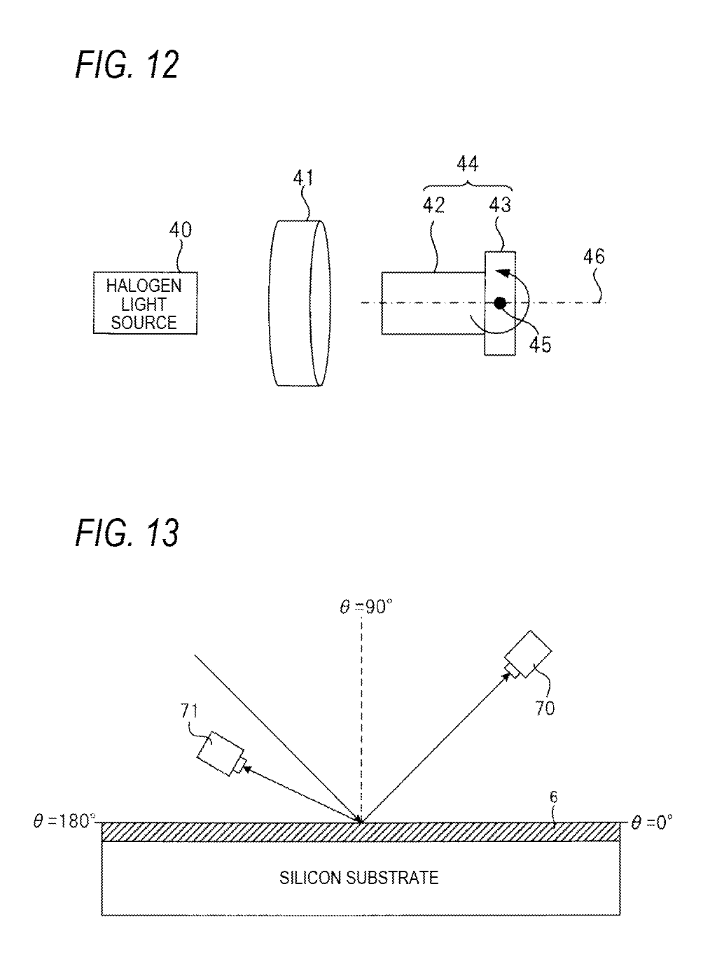

Five optical lenses manufactured in Example 1 were combined with each other so as to manufacture the imaging module illustrated in FIG. 1, and imaging quality was evaluated by using a measurement system illustrated in FIG. 12. Similarly, also in each of Examples 1 to 9, five optical lenses were combined with each other so as to manufacture the imaging module illustrated in FIG. 1, and imaging quality was evaluated by using the measurement system illustrated in FIG. 12. When a distance from a position of the five optical lenses which is farthest from an imaging element to light receiving surface of the imaging element is set to TTL, and a composite focal length of the five optical lenses is set to f, the imaging module was manufactured here in which a value obtained by dividing TTL by f is 1.3 or less.

The measurement system illustrated in FIG. 12 includes a halogen light source 40, a collimator lens 41, and an imaging module 44. Light emitted from the halogen light source 40 is converted into parallel light by the collimator lens 41, and is then incident to a lens group 42 of the imaging module 44. The lens group 42 includes the five optical lenses manufactured in Comparative Example and Examples. The light which has passed through the lens group 42 is incident to an imaging element 43. In this measurement system, the imaging module was rotated by a predetermined angle with respect to a rotation axis 45 which is perpendicular to an optical axis 46 of the lens group 42 and is parallel to a light receiving surface of the imaging element 43, and intensities of main light beams which form an image on the imaging element 43 and other light beams (ghost light beams) were observed and measured, so that an intensity ratio of the ghost light beams to the main light beams was obtained. On the basis of the intensity ratio, a case where ghosting did not occur was evaluated as A, a case where image formation in the imaging element 43 due to light reflected inside the lens group 42 did not cause a practical problem was evaluated as B, and a case where ghosting occurred and thus caused a practical problem was evaluated as C. A configuration and an evaluation result of each optical lens are shown in the following Table 4.

TABLE 4

| | | | Light | | Antireflection Layer | | | | |
|---|---|---|---|---|---|---|---|---|---|
| | Lens Base Material | | Blocking Layer | | (IM Layer) | | Antireflection Layer | | |
| | | Refractive | | Refractive | | Refractive | | Refractive | Evaluation |
| | Material | Index | Material | Index | Material | Index | Material | Index | Result |
| Comparative | a | 1.54 | A | 1.58 | — | — | — | — | C |
| Example 1 | | | | | | | | | |
| Example 1 | a | 1.54 | A (*1) | Table 3 | — | — | — | — | A |
| Example 2 | b | 1.74 | B | 1.7 | — | — | ZnO | 1→1.65 | A |
| Example 3 | a | 1.54 | A | 1.58 | — | — | Al₂O₃ | 1→1.4 | A |
| Example 4 | a | 1.54 | B | 1.7 | — | — | Al₂O₃ | 1→1.4 | A |
| Example 5 | a | 1.54 | B | 1.7 | B | 1.56 | Al₂O₃ | 1→1.4 | A |
| Example 6 | a | 1.54 | A | 1.58 | MgF₂ (*2) | 1.5 | MgF₂ | 1.4 | B |
| Example 7 | a (*3) | 1.54 | B | 1.7 | — | — | ZnO (*4) | 1→1.65 | A |
| Example 8 | b (*3) | 1.74 | B | 1.7 | — | — | Al₂O₃ (*4) | 1→1.4 | B |
| Example 9 | b (*3) | 1.74 | B | 1.7 | — | — | ZnO (*4) | 1→1.65 | A |

(*1) Moth-Eye Structure
(*2) including shavings of A
(*3) No AR Coat
(*4) also provided in lens portion

In Comparative Example 1, since the light blocking layer has the same refractive index on the air layer side as a refractive index on the lens base Material side, ghosting occurred and thus imaging quality was reduced. In contrast, Examples 1 to 9 Showed results in which ghosting did not occur or imaging quality without a practical problem was obtained.

From the results of Examples 1 to 9, it can be seen that, if a refractive index difference between the lens base Material and the light blocking layer is equal to or less than 0.16, reflection of light at an interface between the lens base material and the light blocking layer is minimized and thus imaging quality without a practical problem is obtained.

In Example 7, a difference between a refractive index of the antireflection layer on the lens base material side and a refractive index of the lens base material is 0.11. In Example 9, a difference between a refractive index of the antireflection layer on the lens base material side and a refractive index of the lens base material is 0.09. In Example 8, a difference between a refractive index of the antireflection layer on the lens base material side and a refractive index of the lens base material is 0.34. The evaluation of Example 8 is lower than the evaluation of Examples 7 and 9. Therefore, it can be seen that, if a difference between a refractive index of the antireflection layer on the lens base material and a refractive index of the lens base material is equal to or less than 0.11, reflection of light at an interface between the antireflection layer and the lens base material is minimized, and thus imaging quality is improved.

Next, reflection characteristics of the light blocking portion 6 having the configuration illustrated in FIG. 8 were examined.

The light blocking portion 6 having the configuration illustrated in FIG. 8 was formed on a silicon substrate by the method described in FIGS. 10A to 10C. As the light blocking portion 6, light blocking portions were manufactured in which the average heights H of the convex parts 61 were respectively 55 nm, 165 nm, 275 nm, 360 nm, 400 nm, 500 nm, 620 nm, 880 nm, 1000 nm 1150 nm, and 1400 nm, and the average arrangement pitches T of the convex palls 61 for the respective average heights H were 55 nm, 110 mm, 150 nm, 200 nm, 300 nm, 500 nm, 550 nm, 650 nm, 700 nm, and 850 nm. In the light blocking portions manufactured here, the average height H and the average arrangement pitch T of the convex parts 61 were measured by wing a confocal laser microscope (for example, OLS3000 manufactured by Olympus Corporation).

In the light blocking portion 6 manufactured in the above-described manner, reflection characteristics of four items were measured by using a measurement system illustrated in FIG. 13.

FIG. 13 is a diagram illustrating a measurement system of Example. In the measurement system illustrated in FIG. 13, a direction perpendicular to a silicon substrate is defined as a direction of 90° with respect to the silicon substrate, and an angle decreases when tilted toward the right side from this direction and is set to 0° in a direction which is parallel to the silicon substrate and is directed toward the right side of the figure. In addition, an angle increases when tilted toward the left side from the direction of 90° and is set to 180° in a direction which is parallel to the silicon substrate and is directed toward the left side of the figure.

As shown in the following Table 5, an angle of incident light was set, and arrangement angles of a light amount detector 70 and a camera 71 were set, so that an amount of regularly reflected light and an amount of backward reflected light were measured by the light amount detector 70. A distribution of regularly reflected light and a distribution of backward reflected light were measured by the camera 71. As incident light, light which was circularly polarized via a. Gan-Thompson polarizer and a phase difference plate by using a single-mode He—Ne laser (wavelength of 633 nm) was used.

TABLE 5

| | | Angle of | Angle of Light | Angle |
|---|---|---|---|---|
| | | Incident | Amount | of |
| | Measured Item | Light | Detector | Camera |
| Measurement 1 | Amount of | 150° | 30° | — |
| | Regularly | | | |
| | Reflected Light | | | |
| Measurement 2 | Distribution of | 150° | — | 30° |
| | Regularly | | | |
| | Reflected Light | | | |
| Measurement 3 | Amount of | 120° | 150° | — |
| | Backward | | | |
| | Reflected Light | | | |
| Measurement 4 | Distribution of | 120° | — | 150° |
| | Backward | | | |
| | Reflected Light | | | |

In Measurement 1, an amount of regularly reflected light which was measured by using a blocking instead of the light block portion was set to 100%, and a reflectance (regular reflectance) was calculated which was a ratio of an amount of regularly reflected light measured for the light blocking portion to a light amount of 100%.

In Measurement 3, scattered light beams which are spread in a range of ±20° with respect to a direction of 150° are collected with a lens and are introduced into the light amount detector, and an amount of backward reflected light was measured. When power of an amount of incident light was set to 1 W, and power (1 mW) of 1/1000 of this power was set as a threshold value, it was determined that backward scattering is present if measured power of an amount of backward reflected light was equal to or greater than the threshold value, and it was determined that no backward scattering is present if measured power of an amount of backward reflected light was smaller than the threshold value.

Measurement 3 was set to an angle of incident light different from an angle of Measurement 1. This is because, if an angle of incident light is set to 150°, the light amount detector cannot be located in the direction of 150°, and thus an amount of scattered light which is spread in a range centering on the direction of 150° cannot be measured.

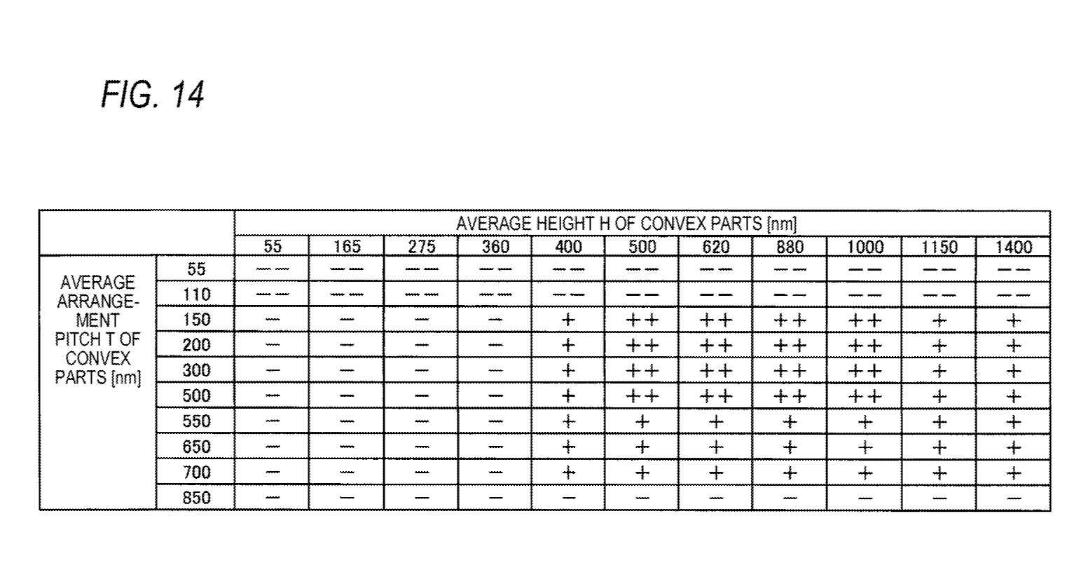

FIG. 14 illustrates a result in which regular reflectances obtained for all the manufactured light blocking portions and whether or not backward scattering has occurred are collected.

In FIG. 14, a result indicated by “−−” indicates that backward scattering is present and regular reflectance is 1% or lower. A result indicated by “−” indicates that backward scattering is not present and regular reflectance is 5% or higher. A result indicated by “+” indicates that backward scattering is not present and regular reflectance is 1% or higher and 5% or lower. A result indicated by “++” indicates that backward scattering is not present and regular reflectance is 1% or lower.

A simulation was performed for the intensity of ghosting (at an incidence angle of) 150°) occurring in an imaging module provided with each light blocking portion which was manufactured by using the configuration of FIG. 6 as a model. As a result, in FIG. 14, it was found that ghosting with intensity which caused a practical problem occurred in the light blocking portion with “−−” and the light blocking portion with “−”. On the other hand, ghosting occurred in the light blocking portion with “+”, but the intensity thereof was not enough to cause a practical problem. In addition, ghosting did not occur in the light blocking portion with “++”.

It can be seen from the above description that, if the average height H of the convex parts 61 located on the surface of the light blocking portion 6 is set to 400 nm or more, and the average arrangement pitch T of the convex parts 61 is set to 150 nm or more and 700 nm or less, ghosting can be minimized up to a level which causes no practical problems.

It can be seen from the above description that, if the average height FI of the convex parts 61 located on the surface of the light blocking portion 6 is set to 500 nm or more and 1000 nm or less, and the average arrangement pitch T of the convex parts 61 is set to 150 nm or more and 500 nm or less, the occurrence of ghosting can be reliably minimized.

As described above, the present specification discloses the following matters.

It is disclosed an optical element including: an optical base material that transmits light therethrough; and a light blocking portion that is formed on part of a surface of the optical base material, in which the light blocking portion includes a light blocking layer; and an antireflection layer that is formed on a non-adhesion surface with the optical base material in the light blocking layer, and in which a refractive index of the antireflection layer is lower than a refractive index of the light blocking layer.

The optical element may have a configuration, in which the antireflection layer is also formed on at least part of a non-adhesion surface with the light blocking layer in the surface of the optical base material.

The optical element may have a configuration, in which the antireflection layer is also formed on both of the non-adhesion surfaces, and in which a difference between a refractive index of the optical base material and a refractive index of the antireflection layer is 0.11 or less.

The optical element may have a configuration, in which a refractive index of the antireflection layer gradually increases from a surface thereof which is in contact with air toward the light blocking layer.

The optical element may have a configuration, in which the antireflection layer is constituted by a laminate of a plurality of films having different refractive indexes.

The optical element may have a configuration, in which a difference between a refractive index of the optical base material and a refractive index of the light blocking layer is 0.16 or less.

The optical element may have a configuration, in which the optical base material has a function of attenuating infrared rays, in which the antireflection layer has a configuration in which a plurality of convex parts are arranged on the light blocking layer in a two-dimensional form, in which an average height of the convex parts is 400 nm or more, and in which an average arrangement pitch of the convex parts is 150 nm or more and 700 nm or less.

The optical element may have a configuration, in which the average height of the convex parts is 500 nm or more and 1000 nm or less, and in which the average arrangement pitch of the convex parts is 150 nm or more and 500 nm or less.

It is disclosed a lens unit including the optical element, in which the optical element is an optical lens, and the one or more optical lenses are arranged in an optical axis direction.

It is disclosed an imaging module including: the lens unit; and an imaging element that images a subject through the lens unit.

The imaging module may have a configuration, in which when a distance from a part which is closest to a subject in the one or more optical lenses to the imaging element is set to TTL, and a composite focal length of the one or more optical lenses is set to f, TTL/f≦1.3 is satisfied.

It is disclosed an electronic apparatus including the imaging module.

The present invention is highly convenient and effective to be applied to a portable electronic apparatus such as a digital camera or a mobile phone in particular.

What is claimed is:

1. An optical element comprising:
an optical base material that transmits light therethrough; and
a light blocking portion that is formed on part of a surface of the optical base material,
wherein the light blocking portion includes
a light blocking layer; and
an antireflection layer that is formed on a non-adhesion surface with the optical base material in the light blocking layer, and
a refractive index of the antireflection layer is lower than a refractive index of the light blocking layer.

2. The optical element according to claim 1,
wherein the antireflection layer is also formed on at least part of a non-adhesion surface with the light blocking layer in the surface of the optical base material.

3. The optical element according to claim 2,
wherein the antireflection layer is also formed on both of the non-adhesion surfaces, and
a difference between a refractive index of the optical base material and a refractive index of the antireflection layer is 0.11 or less.

4. The optical element according to claim 1,
wherein a refractive index of the antireflection layer gradually increases from a surface thereof which is in contact with air toward the light blocking layer.

5. The optical element according to claim 4,
wherein the antireflection layer is constituted by a laminate of a plurality of films having different refractive indexes.

6. The optical element according to claim 1,
a difference between a refractive index of the optical base material and a refractive index of the light blocking layer is 0.16 or less.

7. The optical element according to claim 1,
wherein the optical base material has a function of attenuating infrared rays,
the antireflection layer has a configuration in which a plurality of convex parts are arranged on the light blocking layer in a two-dimensional form,
an average height of the convex parts is 400 nm or more, and
an average arrangement pitch of the convex parts is 150 nm or more and 700 nm or less.

8. The optical element according to claim 7,
wherein the average height of the convex parts is 500 nm or more and 1000 nm or less, and
wherein the average arrangement pitch of the convex parts is 150 nm or more and 500 nm or less.

9. A lens unit comprising the optical element according to claim 1,
wherein the optical element is an optical lens, and the one or more optical lenses are arranged in an optical axis direction.

10. An imaging module comprising:
the lens unit according to claim 9; and
an imaging element that images a subject through the lens unit.

11. The imaging module according to claim 10,
wherein, when a distance from a part which is closest to a subject in the one or more optical lenses to the imaging element is set to TTL, and a composite focal length of the one or more optical lenses is set to f, TTL/f≦1.3 is satisfied.

12. An electronic apparatus comprising the imaging module according to claim 10.
